(19) United States
(12) Patent Application Publication
(10) Pub. No.: US 2021/0218850 A1
(43) Pub. Date: Jul. 15, 2021

(54) OPERATION ASSISTANCE SYSTEM, IMAGE PROCESSING APPARATUS, AND OPERATION ASSISTANCE METHOD

(71) Applicant: SHARP KABUSHIKI KAISHA, Osaka (JP)

(72) Inventor: AKIRA OGAWA, Osaka (JP)

(21) Appl. No.: 17/141,804

(22) Filed: Jan. 5, 2021

(30) Foreign Application Priority Data
Jan. 14, 2020 (JP) 2020-003679

(51) Int. Cl. H04N 1/00; H04N 1/32; G02B 27/01

(52) U.S. Cl. CPC H04N 1/00039; H04N 1/00344; G02B 2027/014; H04N 1/3263; G02B 27/017; H04N 1/00543

(57) ABSTRACT

According to an embodiment, an operation assistance system including an image processing apparatus and a wearable terminal is provided. The image processing apparatus includes: at least one state sensor which detects whether the image processing apparatus is in an action required status; a controller which makes a determination related to the action required status; and a communication interface circuit which performs communication related to the action required status with the wearable terminal. The wearable terminal includes: a terminal communication interface circuit; a terminal image-capturing unit; a terminal display unit; and a terminal controller. The controller or the terminal controller recognizes an image of a user's field of view captured by the terminal image-capturing unit, and determines operation assistance information to be displayed on the terminal display unit and a position of the operation assistance information on a display area of the terminal display unit based on the determination.

### BACKGROUND OF THE INVENTION

### Field of the Invention

The present invention relates to an operation assistance system, an image processing apparatus, and an operation assistance method for assisting with an operation on the image processing apparatus, and more particularly, to assisting with the operation of a user for resolving an action required status in which action by the user is required, or the operation of the user for preventing the image processing apparatus from lapsing into the action required status.

### Description of the Background Art

An image processing apparatus which reads an image of a document or prints images may need the action by the user in a case where the image processing apparatus lapses into a state of being unable to continue image processing, or in order to prevent the image processing apparatus from lapsing into the state of being unable to continue the image processing.

For example, in a case where a paper jam caused by a document or printing paper occurs, the user needs to take an action to remove the jammed paper.

Further, when the printing paper has run out or in order to prevent the printing paper from running out, the user needs to supply the printing paper as replenishment.

Furthermore, when the paper discharged to a paper output tray is full or in order to prevent the paper from being full, the user needs to remove the printed paper from the paper output tray.

Moreover, when toner or ink is used up or in order to prevent the toner or ink from being used up, the user needs to supply a refill of the toner or ink.

Also, when a container for collecting the used toner or the used ink is full or in order to prevent the container from being full, the user needs to discard the used toner or the used ink.

Unless an action by the user is taken in such states, the image processing apparatus cannot continue the image processing.

The following technologies are known with respect to the action of the user related to the action required status.

An operation information controller determines whether operation information, which relates to a procedure of operation for resolving a trouble of an image forming apparatus when the trouble occurs, includes an operation which is difficult for the user to execute while referring to a display portion. For example, the above corresponds to an operation on the back side of the image forming apparatus or an interior mechanism which appears when a front panel is opened. When the operation information includes an operation which is difficult to execute while referring to the display portion, image data for displaying the operation information is transmitted to a portable terminal device via a wireless communicator, so that the user can confirm the procedure of operation on the portable terminal device (see, for example, Japanese Unexamined Patent Application Publication No. 2017-208852).

Also, though not related to image processing apparatuses, the technology of displaying, within a field of view of each student attending a lecture class who is wearing a wearable terminal in a learning facility, work assistance information for assisting with the work of a working process of each of the students, is known. For example, a student in a cooking class, who is wearing a spectacle-type wearable terminal, practices cooking by looking at work instruction images and work instruction text displayed on a display region of a display, which is a part of a field of view of the student. The student gives an instruction to change the contents (the next display contents defined in a system in advance or the previous display contents, etc., time information, termination) displayed on the display region of the display by capturing an image of a marker of a specific pattern with a camera being provided in the wearable terminal, or by utterance. A lecturer can give the same instruction or individual instructions to the spectacle-type wearable terminals of all of the students with a lecturer smart device (see, for example, Japanese Unexamined Patent Application Publication No. 2016-62026).

For example, according to the technology of Japanese Unexamined Patent Application Publication No. 2017-208852, it is possible for the user to take an action while looking at a screen of the portable terminal device. However, the user must perform an operation while holding the portable terminal device during execution of the action.

According to the technology of Japanese Unexamined Patent Application Publication No. 2016-62026, a worker can perform the work with his/her hands free without looking away from a work target. However, the contents displayed on the terminal are merely a series of items of work information prepared in advance, and the contents displayed do not change autonomously according to the substance of the action in process.

The present invention has been conceived in view of the above circumstances, and aims to provide to the user appropriate operation assistance information according to a condition related to an action required status of an image processing apparatus.

### SUMMARY OF THE INVENTION

The present invention provides an operation assistance system, which is a system including an image processing apparatus and a wearable terminal, wherein the image processing apparatus comprises: at least one state sensor which detects whether the image processing apparatus is in an action required status in which action by a user is required; a controller which makes a determination related to the action required status based on detection by the state sensor; and a communication interface circuit which communicates with the wearable terminal, the wearable terminal comprises: a terminal communication interface circuit which communicates with the image processing apparatus; a terminal image-capturing unit which captures an image of at least a part of a field of view of the user in a worn state; a terminal display unit which includes a display area overlapping with at least a part of the field of view of the user in the worn state, and displays information; and a terminal controller which causes operation assistance information to be displayed on the terminal display unit based on communication with the image processing apparatus, and one of the controller and the terminal controller recognizes an image of the user's field of view captured by the terminal image-capturing unit, and determines the operation assistance information to be displayed on the terminal display unit and a position of the operation assistance information on the display area based on the determination related to the action required status.

Further, from another aspect, the present invention provides an image processing apparatus which comprises: at least one state sensor which detects whether the image processing apparatus is in an action required status in which action by a user is required; a controller which makes a determination related to the action required status based on detection by the state sensor; and a communication interface circuit which communicates with an external wearable terminal, wherein the communication interface circuit communicates with the wearable terminal, and acquires an image obtained by capturing at least a part of a field of view of the user from the wearable terminal, and the controller recognizes the image acquired from the wearable terminal, determines operation assistance information to be displayed on the wearable terminal based on the determination related to the action required status and the image acquired from the wearable terminal, and sends an instruction to the wearable terminal such that the operation assistance information is displayed correspondingly to a part where the user is to perform an operation.

Furthermore, from yet another aspect, the present invention provides an operation assistance method for an image processing apparatus. The operation assistance method is executed by a controller, and comprises: performing detection, by using a state sensor, of whether the image processing apparatus is in an action required status in which action by a user is required; making a determination related to the action required status based on the detection; communicating with an external wearable terminal, and acquiring an image obtained by capturing at least a part of a field of view of the user from the wearable terminal; recognizing the acquired image; determining, based on the determination related to the action required status and the image acquired from the wearable terminal, operation assistance information to be displayed on the wearable terminal, and a position of the operation assistance information on a display area of the wearable terminal; and sending an instruction to the wearable terminal such that the operation assistance information is displayed on the display area overlapping with at least a part of the field of view of the user.

In the operation assistance system according to the present invention, the controller or the terminal controller recognizes the image of the user's field of view captured by the terminal image-capturing unit, and determines the operation assistance information to be displayed on the terminal display unit and a position of the operation assistance information on the display area, on the basis of the determination related to the action required status. Therefore, it is possible to provide to the user appropriate operation assistance information according to the condition related to the action required status of the image processing apparatus.

### BRIEF DESCRIPTION OF THE DRAWINGS

FIG. 1 is an external perspective view showing a multifunction peripheral according to the present embodiment as one aspect of an image processing apparatus;

FIG. 2 is an external perspective view of the multifunction peripheral shown in FIG. 1 as seen from a different direction;

FIG. 3 is a block diagram showing a configuration of the multifunction peripheral shown in FIG. 1;

FIG. 4 is an external perspective view showing a spectacle-type wearable terminal according to the present embodiment as one aspect of a wearable terminal;

FIG. 5 is a block diagram showing a configuration of the spectacle-type wearable terminal shown in FIG. 4;

FIG. 6 is a first explanatory diagram showing an example of operation assistance information that an operation assistance system is to provide in Embodiment 1;

FIG. 7 is a second explanatory diagram showing an example of operation assistance information that the operation assistance system is to provide in Embodiment 1;

FIG. 8 is a third explanatory diagram showing an example of operation assistance information that the operation assistance system is to provide in Embodiment 1;

FIG. 9 is a fourth explanatory diagram showing an example of operation assistance information that the operation assistance system is to provide in Embodiment 1;

FIG. 10 is a fifth explanatory diagram showing an example of operation assistance information that the operation assistance system is to provide in Embodiment 1;

FIG. 11 is a sixth explanatory diagram showing an example of operation assistance information that the operation assistance system is to provide in Embodiment 1;

FIG. 12 is a seventh explanatory diagram showing an example of operation assistance information that the operation assistance system is to provide in Embodiment 1;

FIG. 13 is an eighth explanatory diagram showing an example of operation assistance information that the operation assistance system is to provide in Embodiment 1;

FIG. 14 is a ninth explanatory diagram showing an example of operation assistance information that the operation assistance system is to provide in Embodiment 1;

FIG. 15 is a tenth explanatory diagram showing an example of operation assistance information that the operation assistance system is to provide in Embodiment 1;

FIG. 16 is a flowchart showing a flow of processing related to the operation assistance information that a controller of the multifunction peripheral shown in FIG. 3 is to execute;

FIG. 17 is a flowchart showing a flow of processing related to the operation assistance information that a terminal controller of the wearable terminal shown in FIG. 5 is to execute; and

FIG. 18 is an explanatory diagram showing an example of operation assistance information that an operation assistance system is to provide in Embodiment 2.

### DESCRIPTION OF THE PREFERRED EMBODIMENTS

The present invention will now be described in detail with reference to the accompanying drawings. Note that the following explanations are merely for describing examples in all respects, and should not be construed as limiting the present invention.

### Embodiment 1

Configuration of Image Processing Apparatus

An operation assistance system according to the present invention includes an image processing apparatus and a wearable terminal. First, a configuration example of the image processing apparatus will be described below.

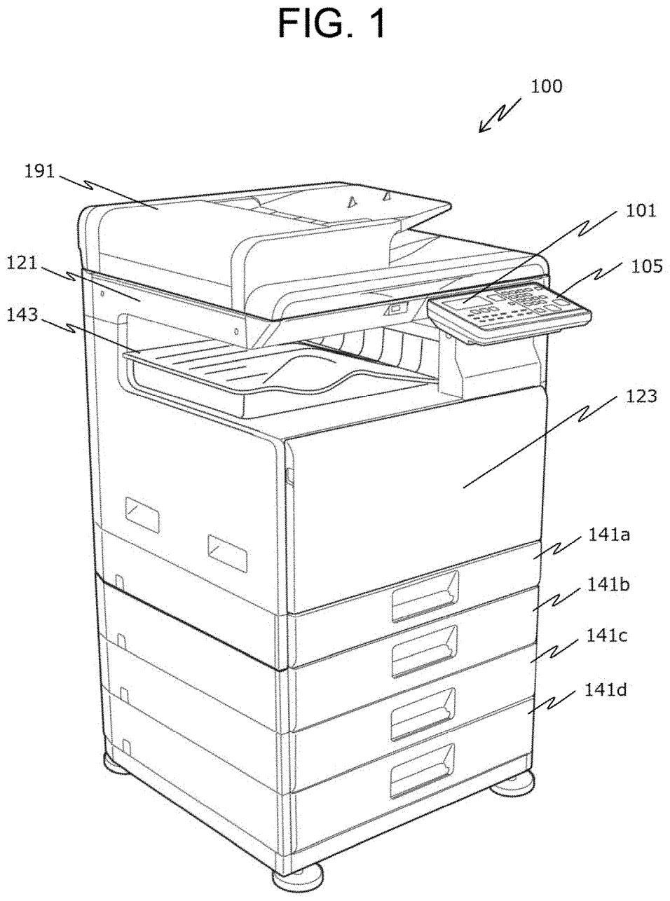

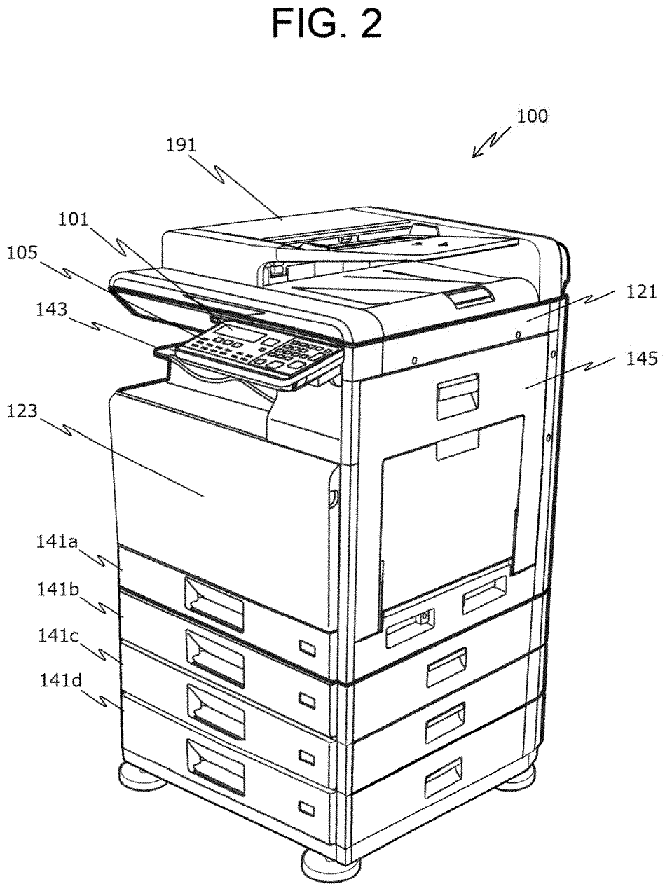

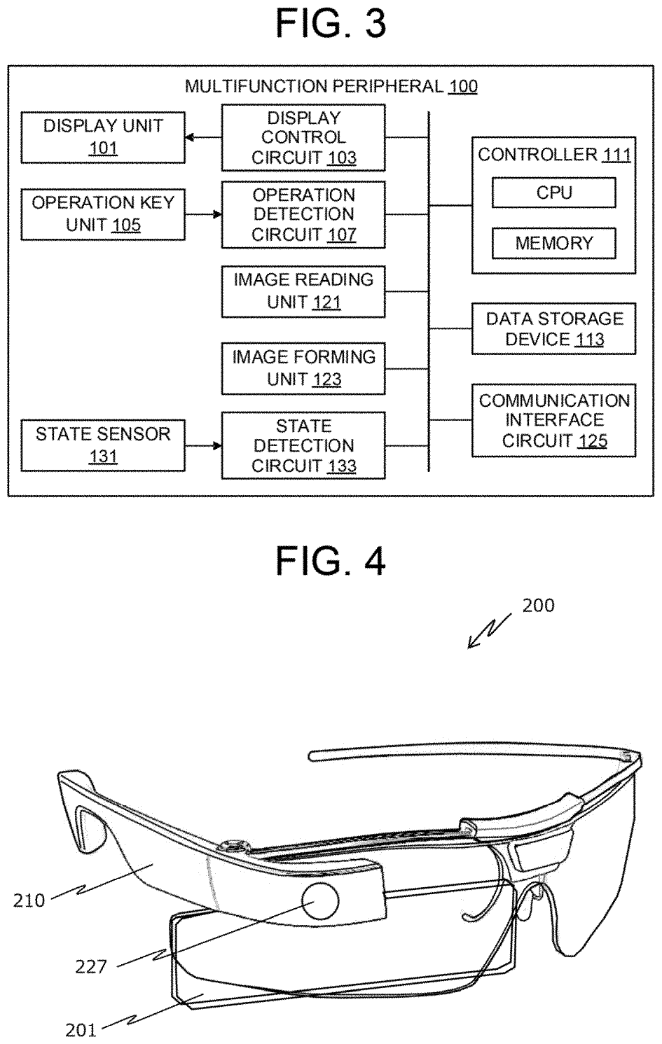

FIG. 1 is an external perspective view showing a multifunction peripheral 100 according to the present embodiment as one aspect of the image processing apparatus. FIG. 2 is an external perspective view of the multifunction peripheral 100 shown in FIG. 1 as seen from a different direction. FIG. 3 is a block diagram showing a configuration of the multifunction peripheral 100 shown in FIG. 1.

As illustrated in FIG. 3, the multifunction peripheral 100 includes a display unit 101, a display control circuit 103, an operation key unit 105, an operation detection circuit 107, a controller 111, and a data storage device 113. Further, an image reading unit 121, an image forming unit 123, a communication interface circuit 125, at least one state sensor 131, and a state detection circuit 133 are provided.

For the display unit 101, a liquid crystal display device, for example, is applied. The display unit 101 displays, with characters or graphics, the state of the multifunction peripheral 100, and information related to an operation received by the operation key unit 105. The display control circuit 103 is a control circuit for causing a display responsive to an instruction of the controller 111 to be displayed on the display unit 101.

The operation key unit 105 detects an operation of a user. The operation detection circuit 107 is a circuit for notifying the controller 111 of the operation detected by the operation key unit 105.

As shown in FIGS. 1 and 2, the display unit 101 and the operation key unit 105 of the multifunction peripheral 100 are provided on a front side of the multifunction peripheral 100 where the user can easily operate the multifunction peripheral 100.

The controller 111 is composed of hardware resources such as a central processing unit (CPU) or a micro-processing unit (MPU), where the CPU and the MPU are both referred to as a CPU for simplicity in the present specification, as the main hardware resource, and a memory, an input-output interface circuit, and a timer circuit.

The controller 111 recognizes the operation of the user on the operation key unit 105 via the operation detection circuit 107, and controls the display of the display unit 101 via the display control circuit 103. Also, the controller 111 recognizes the state of each part of the multifunction peripheral 100 detected by the state sensor 131, and controls the operation.

As the CPU executes an image processing program stored in the memory, processing related to display and operation is controlled. Also, functions related to image processing of the multifunction peripheral 100 such as reading a document image and printing an image are controlled. Furthermore, communication with an external device via the communication interface circuit 125 is controlled.

In other words, as the software resources and hardware resources cooperate with each other, processing related to display and operation, control related to image processing such as printing, and control related to communication, etc., are implemented.

Moreover, apart from the memory of the controller 111, the multifunction peripheral 100 is provided with the data storage device 113. The data storage device 113 includes a rewritable non-volatile storage element. For the non-volatile storage element, a hard disk drive (HDD) or a solid-state drive (SSD), for example, is applied.

The data storage device 113 stores a processing program downloaded to the memory of the controller 111, print data for printing by the image forming unit 123, data of the document image which has been read by the image reading unit 121, and the like.

The communication interface circuit 125 is an interface circuit to allow the multifunction peripheral 100 to communicate with external devices. The external devices with which the communication is performed include a spectacle-type wearable terminal 200 to be described later.

Under the control of the controller 111, the image reading unit 121 feeds a document placed on a document feeder 191 (FIGS. 1 and 2) to read an image of the document, and generates data of the document image. More specifically, image reading in copy, fax, and scanner jobs is executed.

Under the control of the controller 111, the image forming unit 123 performs printing on printing paper for the print data stored in the data storage device 113. More specifically, printing in copy, fax, and printer jobs is executed.

As illustrated in FIGS. 1 and 2, the multifunction peripheral 100 is provided with four paper trays 141a, 141b, 141c, 141d for accommodating the printing paper, and a paper output tray 143 for receiving the printed printing paper.

The paper trays 141a, 141b, 141c, and 141d can accommodate printing paper of various sizes individually. For example, paper of the sizes corresponding to A4, A3, B5, and B4 can be accommodated.

Further, the multifunction peripheral 100 is provided with a paper conveyor (not shown in FIGS. 1 and 2) which feeds, under the control of the controller 111, the printing paper accommodated in one of the paper trays, and conveys the fed printing paper to the image forming unit 123.

The image forming unit 123 prints, under the control of the controller 111, an image based on the print data on the printing paper that the paper conveyor fed from one of the paper trays 141a, 141b, 141c, and 141d.

The paper conveyor further conveys the printing paper subjected to printing by the image forming unit 123 to the paper output tray 143, and discharges the printing paper.

Configuration of Wearable Terminal

Next, the spectacle-type wearable terminal 200 according to the present embodiment will be described.

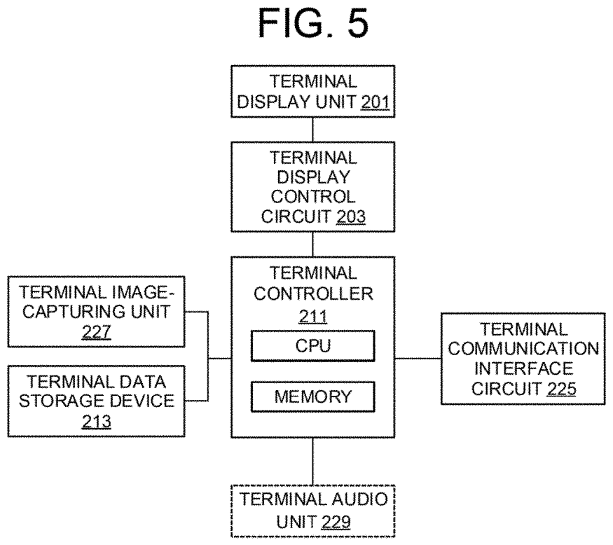

FIG. 4 is an external perspective view showing a spectacle-type wearable terminal according to the present embodiment as one aspect of the wearable terminal. FIG. 5 is a block diagram showing a configuration of the spectacle-type wearable terminal shown in FIG. 4.

As shown in FIG. 5, the spectacle-type wearable terminal 200 includes a terminal display unit 201, a terminal display control circuit 203, a terminal controller 211, a terminal data storage device 213, a terminal communication interface circuit 225, and a terminal image-capturing unit 227. Further, a terminal audio unit 229 may be provided.

For the terminal display unit 201, a holographic optical element, for example, is applied. The terminal display unit 201 shown in FIG. 4 can display characters and graphics information to be superimposed on a field of view of the left eye of the user wearing the wearable terminal. The display of the terminal display unit 201 is presented in the state of being translucent and thus does not obstruct the field of view of the user completely. The terminal display control circuit 203, the terminal controller 211, the terminal data storage device 213, and the terminal communication interface circuit 225, together with a battery not shown, are incorporated into a temple 210 of the spectacle-type wearable terminal.

The terminal controller 211 is composed of hardware resources such as a CPU as the main hardware resource, and a memory, an input-output interface circuit, and a timer circuit.

The terminal controller 211 controls the display of the terminal display unit 201 via the terminal display control circuit 203. The terminal display control circuit 203 causes the display responsive to an instruction of the terminal controller 211 to be displayed on the terminal display unit 201.

As the CPU executes a control program stored in the memory, the display of the terminal display unit 201 and the function related to image capturing of the terminal image-capturing unit 227 are controlled. Further, communication with the multifunction peripheral 100 via the terminal communication interface circuit 225 is controlled.

In other words, as the software resources and hardware resources cooperate with each other, control related to processing of display and image capturing, and control related to communication, etc., are implemented.

Also, apart from the memory of the terminal controller 211, the wearable terminal 200 is provided with the terminal data storage device 213. The terminal data storage device 213 includes a rewritable non-volatile storage element. For the non-volatile storage element, a flash memory, for example, is applied.

The terminal data storage device 213 stores a processing program downloaded to the memory of the terminal controller 211, an image captured by the terminal image-capturing unit 227, display data to be displayed on the terminal display unit 201, and the like.

The terminal communication interface circuit 225 is an interface circuit to allow the wearable terminal 200 to communicate with the multifunction peripheral 100 and external devices.

Further, the wearable terminal 200 may be provided with the terminal audio unit 229. The terminal audio unit 229 notifies the user wearing the wearable terminal 200 of information by voice or sound. Further, the terminal audio unit 229 acquires the user's utterance, recognizes a voice of the user's instruction or question, etc., and notifies the terminal controller 211 of the recognized instruction or question, etc. The terminal controller 211 performs processing responsive to the instruction or question, etc. Depending on the content of the instruction or question, the terminal controller 211 may transmit information related to the instruction or question to the multifunction peripheral 100, and have the processing performed at the side of the multifunction peripheral 100. Alternatively, it is possible to assume a mode of sending the information to an external server or the like via the multifunction peripheral 100, and having the processing performed externally.

Processing related to Operation Assistance Information

A specific example of operation assistance information, which the operation assistance system according to the present embodiment provides to the user, will be described below. The action that the user is to take in an action required status includes various modes. Clearing of a paper jam, supply of printing paper as replenishment, removal of the printed paper from the paper output tray being full, replacement or refilling of toner or ink, replacement of a collection container for the used toner or ink, and the like, are typical examples of the above-mentioned action. Other than the above, some models assume the user to replace or perform maintenance of the image forming unit or the other units and parts.

In the present embodiment, specific modes of the operation assistance information to be provided will be described by taking the case of clearing a paper jam caused by the printing paper as an example. More specifically, operation assistance information to be presented in a case of clearing a paper jam, which has occurred in a conveyance path for the printing paper extending from the paper tray 141a to the paper output tray 143, will be described.

It is assumed that, in the conveyance path, the state sensors 131 for detecting the presence or absence of the printing paper are disposed in a plurality of places. The controller 111 of the multifunction peripheral 100 monitors the presence or absence of the printing paper that each of the state sensors 131 disposed in the conveyance path detects during execution of a print job.

If there occur such situations as the printing paper does not arrive at a certain part regardless of being at a prescribed timing, or the printing paper does not move from the certain part and is stuck at that part even after elapse of a prescribed timing, the controller 111 controls driving of the conveyance path to stop the feeding and conveyance of the subsequent printing paper.

Therefore, there may be a case where the conveyance stops in a state where the conveyance path includes not only the printing paper at a part where the paper jam has occurred but also the subsequent printing paper on the paper tray side (that is, the upstream side) relative to the part in question.

The controller 111 controls the driving of the conveyance path such that the printing paper on the downstream side, which is the paper conveyed prior to the printing paper causing the paper jam, is conveyed to the paper output tray 143, if possible. However, at a part where the driving is not separated from the driving of the part where the paper jam has occurred, the conveyance stops as the conveyance of the printing paper causing the paper jam is stopped. Therefore, there may be a case where the conveyance stops in a state where the conveyance path includes not only the printing paper at the part where the paper jam has occurred but also the printing paper on the downstream side relative to the part in question.

Together with stopping the conveyance of the printing paper due to the occurrence of the paper jam, the controller 111 displays the matter that the paper jam has occurred and a part having the paper jam on the display unit 101, thereby notifying the user of the state of the paper jam. In addition, the matter that the user can take the action while looking at the operation assistance information by wearing the wearable terminal 200 may be displayed on the display unit 101.

The controller 111 does not only display the occurrence of the paper jam on the display unit 101, but also transmits information related to the state of the paper jam to the wearable terminal 200. In connection with the above, the wearable terminal 200 may be kept near the multifunction peripheral 100 so that the operation assistance information can be provided thereto. Alternatively, it is possible to register information related to the wearable terminal 200 that the user owns in advance, and store the information in the data storage device 113. In that case, when the user uses the multifunction peripheral 100 by performing user authentication, for example, the controller 111 provides the operation assistance information to the wearable terminal 200 that has been registered to be linked to the user.

Further, the controller 111 displays a procedure of operation for the user to clear the paper jam on the display unit 101, and provides the wearable terminal 200 with the operation assistance information.

Display of an operation procedure for clearing the paper jam on the display unit 101 is a conventionally employed technology. For this reason, explanation will be provided below focusing on the operation assistance information to be provided by the wearable terminal 200. The operation assistance system according to the present embodiment allows the operation assistance information, which is easy to understand to the user, to be displayed on the side of the wearable terminal 200 even if the multifunction peripheral 100 having a small display unit 101 which cannot perform graphics display is employed.

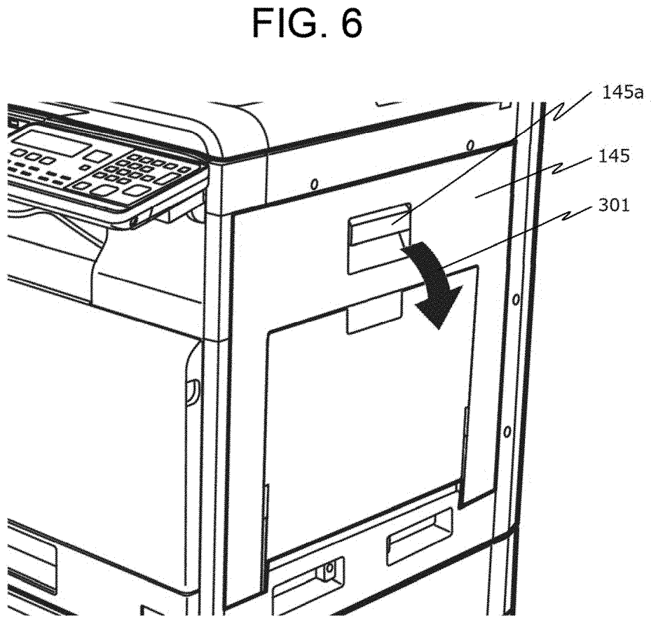

FIGS. 6 to 15 are explanatory diagrams each showing an example of the operation assistance information that the operation assistance system provides to the user by using the wearable terminal 200 in the present embodiment. The explanatory diagrams show the field of view of the user wearing the wearable terminal 200.

When the controller 111 determines that a paper jam has occurred in the conveyance path on the basis of detection performed by the state sensor 131, the controller 111 sends a notification to the wearable terminal 200 that the operation assistance information should be displayed on the basis of information related to the detected state.

The terminal controller 211 of the wearable terminal 200 which has received the notification performs an operation guide display for the operation of opening a side cover 145 as the initial operation assistance information. Specifically, as shown in FIG. 6, when the side cover 145 comes into the field of view of the user, it is determined that an operation guide for operating a side cover handle 145a and opening the side cover 145 should be displayed.

Further, an operation guide display 301, which is shaped like an arrow conforming to the position and direction of the operation to be performed, is displayed at a position on the terminal display unit 201 corresponding to the side cover handle 145a that has come into the user's field of view. Note that the arrow is merely an example. For example, a message may be displayed. That is, graphics such as an arrow may be displayed together with a message. Preferably, the operation guide display 301 should be displayed in the state of being translucent so as not to obstruct or block the field of view of the user.

Note that the terminal controller 211 determines the position on the terminal display unit 201, which corresponds to the side cover handle 145a, by referring to an image of the user's field of view captured by the terminal image-capturing unit 227. In the image of the user's field of view captured by the terminal image-capturing unit 227, a predetermined marker may be assigned to a part where the user is to operate such as the side cover handle 145a, so as to allow the user to easily and accurately recognize the part to be operated. If unique markers are assigned to a plurality of parts to be operated, respectively, it is possible to more easily and accurately specify those parts.

When the user moves, the user's viewpoint moves accordingly. When the user's viewpoint is moved, the terminal controller 211 updates the position on the terminal display unit 201, which corresponds to the side cover handle 145a. Moreover, preferably, the direction of the arrow of the operation guide display 301 should be updated as the user's viewpoint is moved. Consequently, when the user's viewpoint is moved, the position and the direction of the operation guide display 301 are updated, and the operation to be performed is displayed to the user in an easy-to-understand manner.

As a different mode, the terminal controller 211 may perform the control such that the images of the user's field of view captured by the terminal image-capturing unit 227 are sequentially transmitted to the multifunction peripheral 100, and the multifunction peripheral 100 which has received the images, more specifically, the controller 111, may determine the content and the position of the operation guide display 301 to be displayed on the terminal display unit 201. Further, information related to the determined operation guide display 301 may be transmitted to the wearable terminal 200. The terminal controller 211 causes the terminal display unit 201 to display the operation guide display 301 on the basis of the information received from the multifunction peripheral 100.

As shown in FIG. 6, the position where the operation guide display 301 is to be displayed does not need to exactly match with the position of the side cover handle 145a which is to be operated by the user, and may be a position near the side cover handle 145a.

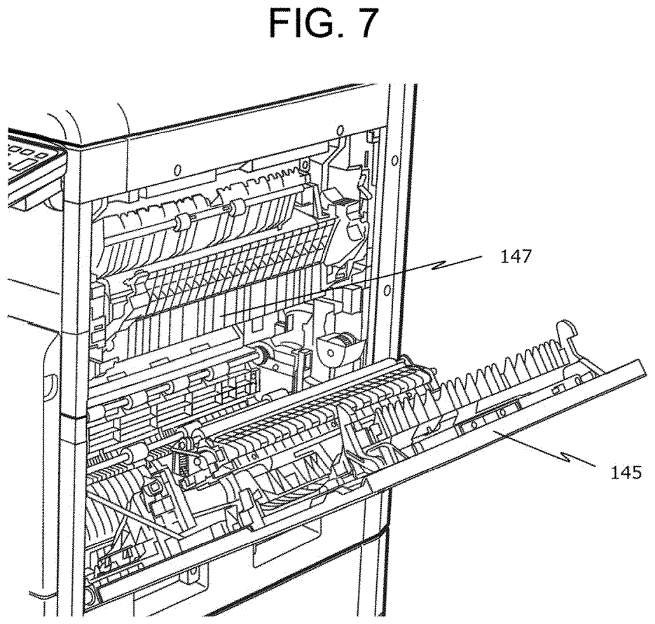

When the user opens the side cover 145 in accordance with the operation guide display 301, and a conveyance path 147 (FIG. 7) inside the multifunction peripheral is exposed, the controller 111 recognizes that the state of the side cover 145 has been changed from closed to open on the basis of detection performed by the state sensor 131, and notifies the wearable terminal 200 of the change.

The terminal controller 211 which has received the notification causes an operation guide display for removing the jammed printing paper to be displayed at a part determined to be including the printing paper.

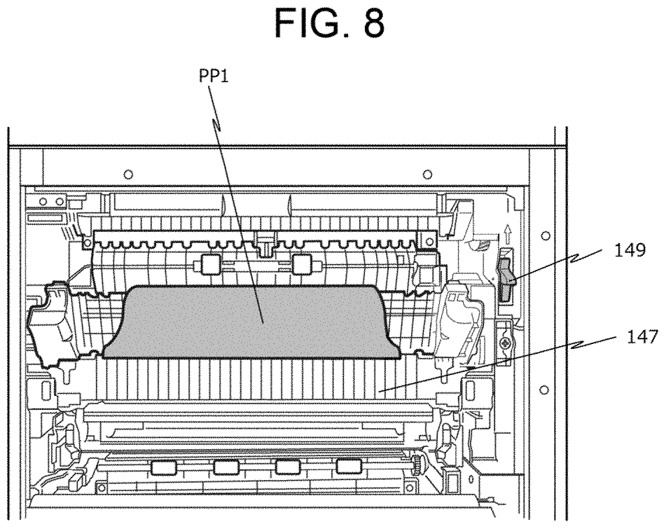

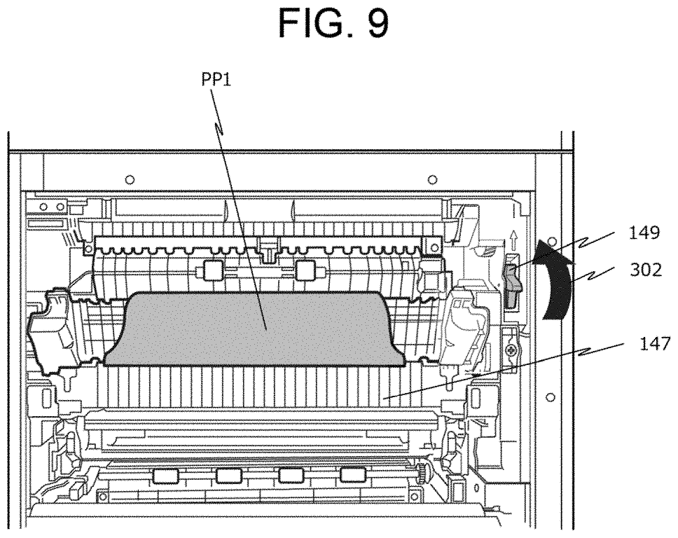

For example, when it is determined that printing paper PP1 is at a position shown in FIG. 8, the terminal controller 211 displays, on the terminal display unit 201, an operation guide display 302 indicating that a paper feed knob 149 should be turned upward in order to remove the printing paper PP1. More specifically, the terminal controller 211 causes the operation guide display 302, which is shaped like an arrow conforming to the position and direction of the operation to be performed, to be displayed at a position on the terminal display unit 201 corresponding to the paper feed knob 149 that has come into the user's field of view (see FIG. 9).

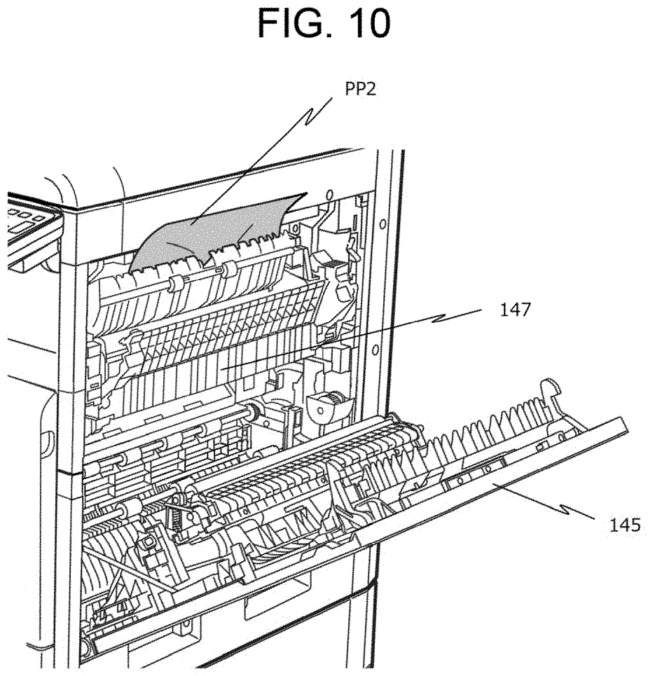

Further, when it is determined that printing paper PP2 is at a position shown in FIG. 10, for example, the controller 111 notifies the wearable terminal 200 of that state.

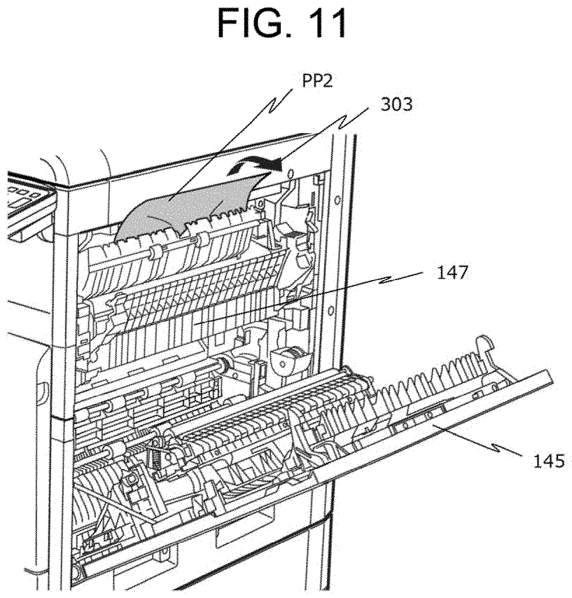

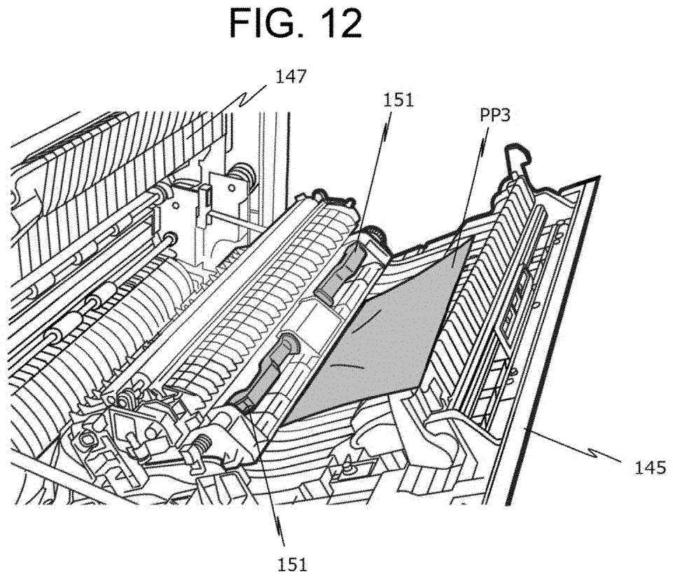

The terminal controller 211 which has received the notification displays, on the terminal display unit 201, an operation guide display 303 indicating that a front edge of the printing paper PP2 should be pulled out toward the front side in order to remove the printing paper PP2. More specifically, the operation guide display 303, which is shaped like an arrow conforming to the position and direction of the operation to be performed, is displayed at a position on the terminal display unit 201 corresponding to a part with the stuck printing paper PP2 that has come into the user's field of view (see FIG. 11).

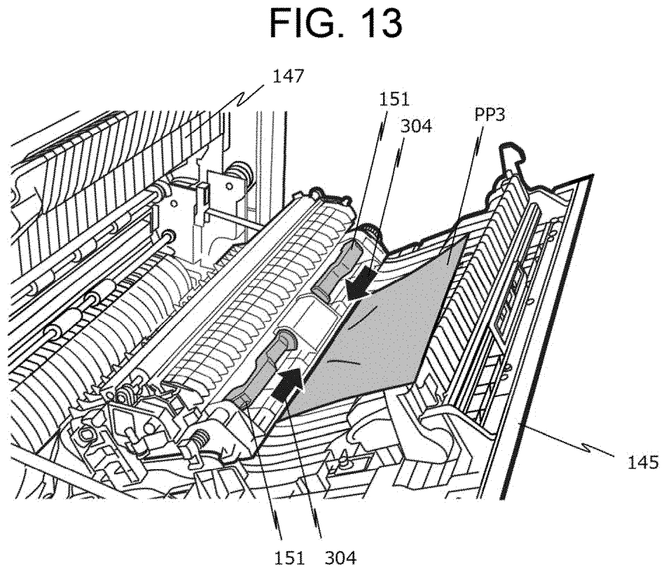

Furthermore, when it is determined that printing paper PP3 is at a position shown in FIG. 12, for example, the controller 111 notifies the wearable terminal 200 of that state.

The terminal controller 211 which has received the notification causes operation guide displays to be displayed on the terminal display unit 201. The operation guide displays are those indicating that, in order to remove the printing paper PP3, the printing paper PP3 should be drawn out toward the front side while holding and lifting up right-and-left double-sided conveyor levers 151. More specifically, operation guide displays 304, which are shaped like an arrow conforming to the position and direction of the operation of drawing the right-and-left double-sided conveyor levers 151 toward the center, are displayed at positions on the terminal display unit 201 corresponding to the double-sided conveyor levers 151 that have first come into the user's field of view (see FIG. 13).

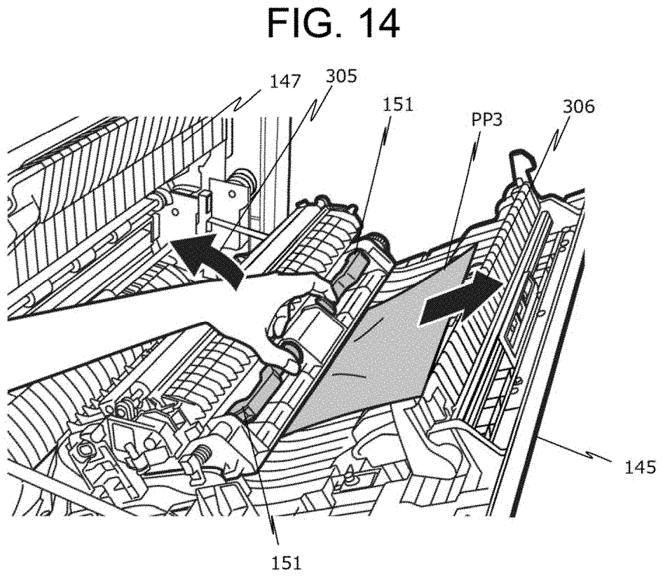

When the user holds the double-sided conveyor levers 151 and draws them toward the center in accordance with the operation guide displays 304, the terminal controller 211 then displays the next operation guide display. First, an operation guide display 305, which is shaped like an arrow conforming to the position and direction of the operation of lifting the held double-sided conveyor levers 151 upward, is displayed at a position on the terminal display unit 201 corresponding to the double-sided conveyor levers 151. Further, an operation guide display 306, which is shaped like an arrow conforming to the position and direction of the operation of drawing out the printing paper PP3 toward the front side, is displayed (see FIG. 14).

The terminal controller 211 may determine the timing of switching the display from the operation guide displays 304 to the operation guide displays 305 and 306 as described below.

First, the case where the multifunction peripheral 100 includes the state sensor 131 for detecting the position of the double-sided conveyor levers 151 will be described. When the state sensor 131 detects that the double-sided conveyor levers 151 have been drawn to the center, the controller 111 notifies the wearable terminal 200 of a change in the state. The terminal controller 211 which has received the notification causes the operation guide displays 304 to be switched to the operation guide displays 305 and 306.

Further, in a case where the multifunction peripheral 100 does not include the state sensor 131 for detecting the position of the double-sided conveyor levers 151, the operation guide displays 304 may be switched to the operation guide displays 305 and 306 when the terminal controller 211 recognizes that the double-sided conveyor levers 151, which are included in the image captured by the terminal image-capturing unit 227, are in the state of having been drawn toward the center. While the image recognition may be carried out by the terminal controller 211, the controller 111 may carry out the image recognition as an alternative mode. For the image recognition, a well-known technique may be applied. When the controller 111 is to recognize an image, the terminal controller 211 sequentially transmits the images captured by the terminal image-capturing unit 227 to the multifunction peripheral 100 to provide the multifunction peripheral 100 with the captured images.

The above explanation describes removal of the printing paper at parts where paper jams have occurred. However, there may be a case where the subsequent printing paper remains to be stuck at the upstream side of the conveyance path. Further, the preceding printing paper may remain to be stuck at the downstream side of the conveyance path. In that case, the user needs to remove those pieces of stuck printing paper as well. However, the operation for removal is the same as that for removing the printing paper at the part where the paper jam has occurred. Therefore, the operation guide display is the display performed sequentially by combining the operation guide displays for removing the pieces of jammed printing paper at different parts.

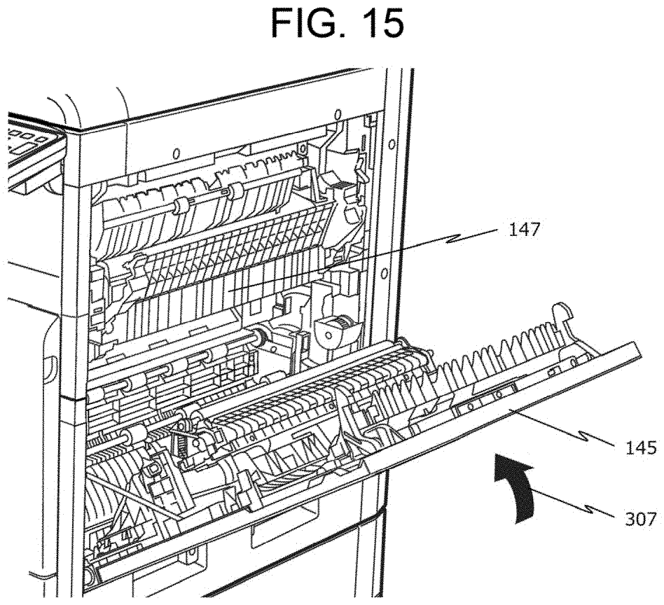

Further, if the controller 111 or the terminal controller 211 determines that all pieces of printing paper in the conveyance path have been removed on the basis of a result of detection by the state sensor 131 or the image recognition, the terminal controller 211 may display an operation guide display as described below. That is, an operation guide display 307, which is shaped like an arrow conforming to the position and direction of the operation of closing the side cover 145, is displayed at a position on the terminal display unit 201 corresponding to the side cover 145 (see FIG. 15).

The above corresponds to the examples of the specific modes of the operation assistance information that the operation assistance system according to the present embodiment provides to the user.

Flowchart

A process in which the operation assistance system according to the embodiment provides the operation assistance information to the user will be described with reference to flowcharts.

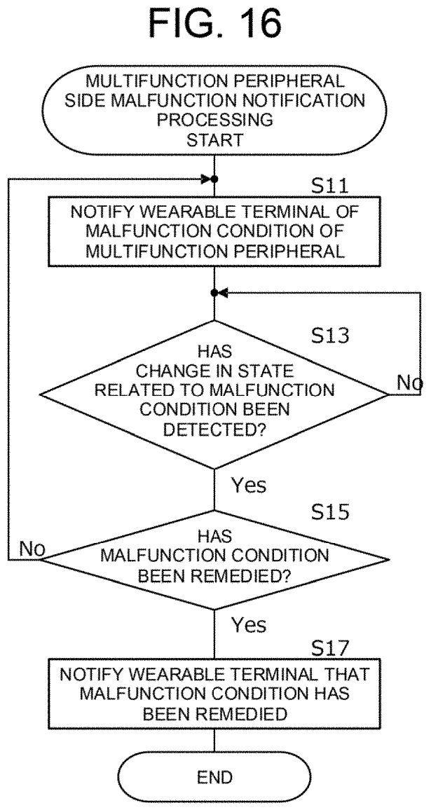

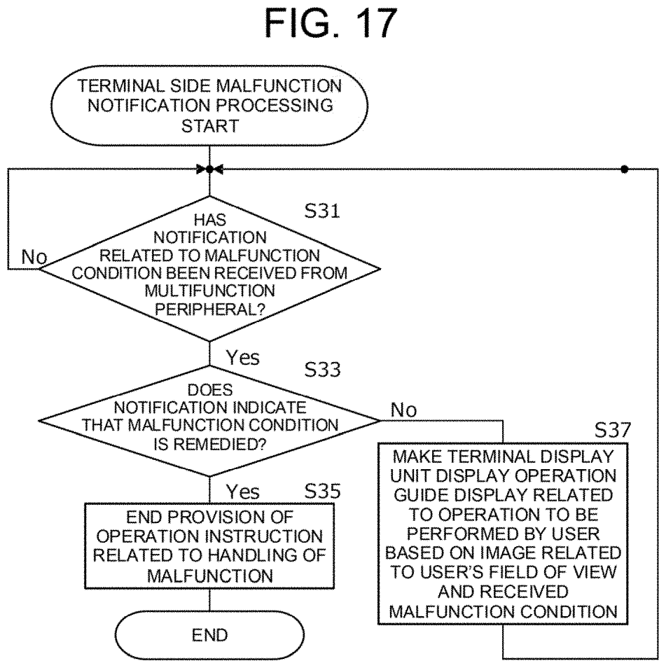

FIG. 16 is a flowchart showing a flow of processing related to the operation assistance information that the controller of the multifunction peripheral shown in FIG. 3 is to execute. Also, FIG. 17 is a flowchart showing a flow of processing related to the operation assistance information that the terminal controller of the wearable terminal shown in FIG. 5 is to execute.

As shown in FIG. 16, when it is determined by the controller 111 of the multifunction peripheral 100 that the state sensor 131 detects that the multifunction peripheral 100 has lapsed into an action required status, the controller 111 determines in what condition the multifunction peripheral is, and sends a notification related to a malfunction condition to the wearable terminal (step S11). Here, the malfunction condition refers to a condition related to the action required status of the multifunction peripheral 100.

Next, the controller 111 monitors whether an action has been taken to remedy the malfunction condition, and whether the state sensor 131 has detected a change in the state (step S13).

When a change in the state is detected (Yes in step S13), the controller 111 determines whether the state is that in which the malfunction condition has been remedied (step S15).

If the malfunction condition has not been remedied yet (No in step S15), the controller 111 returns the processing to that of step S11 described above, and sends a notification related to the changed state to the wearable terminal.

Meanwhile, if the controller 111 determines that the malfunction condition has been remedied (Yes in step S15), the controller 111 sends a notification indicating that the malfunction condition has been remedied to the wearable terminal 200 (step S17), and ends the processing.

The above is the flow of processing that the controller 111 executes on the side of the multifunction peripheral 100.

Correspondingly to the above-described processing, the terminal controller 211 of the wearable terminal 200 executes the processing described below.

As shown in FIG. 17, the terminal controller 211 monitors whether a notification of the state related to the malfunction condition has been sent from the multifunction peripheral 100 (step S31).

When the terminal controller 211 has received the notification related to the malfunction condition (Yes in step S31), the terminal controller 211 determines whether the notification indicates that the malfunction condition is remedied (step S33).

If the notification does not indicate that the malfunction condition has been remedied (No in step S33), the terminal controller 211 displays, on the terminal display unit 201, an operation guide display related to the operation that the user is to perform, on the basis of the state ascertained by reception from the multifunction peripheral 100, and the image of the user's field of view captured by the terminal image-capturing unit 227 (step S37). Then, the terminal controller 211 returns the processing to that of step S31 described above, and waits for the next notification.

Here, it is assumed that the terminal data storage device 213 stores in advance data of a malfunction list in which all of the malfunction conditions receivable from the multifunction peripheral 100 and the operation guide displays to be displayed for the respective malfunction conditions are associated with each other. When the terminal controller 211 receives a notification related to the malfunction condition from the multifunction peripheral 100, the terminal controller 211 checks on the malfunction list and determines the type of operation guide display to be displayed. However, at what position and in which direction the operation guide display should be displayed are determined by referring to the image of the user's field of view captured by the terminal image-capturing unit 227.

For example, the case of receiving a notification, which indicates that a paper jam has occurred in the conveyance path, from the multifunction peripheral 100 will be described. It is assumed that the controller 111 sends the notification together with information representing detection performed by the state sensor 131 in the conveyance path and the closed state of the side cover.

The terminal controller 211 which has received the notification refers to the malfunction list stored in the terminal data storage device 213. Then, it is determined that the operation guide display 301 (FIG. 6) for opening the side cover 145 should be displayed on the terminal display unit 201.

When the user opens the side cover 145, the state sensor 131 detects that the side cover 145 is open. The controller 111 sends, to the wearable terminal 200, a notification indicating that the state of the side cover has been changed to open, and that the state of the paper jam shows no change.

In response to the notification, the terminal controller 211 further refers to the malfunction list, and displays, on the terminal display unit 201, the operation guide display suited with the detection by the state sensor 131 in the conveyance path.

Meanwhile, if it is determined that a notification indicating that the malfunction condition is remedied has been received in the aforementioned step S33, the terminal controller 211 stops providing the operation guide display (step S35) and ends the processing.

For example, when the user removes all pieces of printing paper on the conveyance path and closes the side cover, the controller 111 of the multifunction peripheral 100 determines that the state of having the paper jam has been resolved in view of the facts that the state of the side cover has been changed to closed, and that all of the state sensors 131 in the conveyance path detect the states of no printing paper. Then, a notification to that effect is sent to the wearable terminal 200. The terminal controller 211 of the wearable terminal 200 which has received the notification stops the operation guide display. In doing so, the operation guide display may be stopped after a message indicating that the paper jam state is resolved has been displayed.

Note that the processing shown in FIG. 17 is based on the premise that the terminal controller 211 determines the content and the display position of the operation guide display, on the basis of the image related to the user's field of view, and the malfunction condition received from the multifunction peripheral 100, in other words, the information related to the action required status. However, the controller 111 of the multifunction peripheral 100 may perform all of or part of those processing steps. Further, all of or part of those processing steps may be executed by an external server or the like which directly or indirectly communicates with the wearable terminal 200 via the multifunction peripheral 100. Also, the terminal controller 211 or the controller 111 and the external server, etc., may cooperate with each other to execute all of or part of those processing steps.

In doing so, the terminal controller 211 may provide the multifunction peripheral 100 with the images of the user's field of view captured by the terminal image-capturing unit 227, and the controller 111 of the multifunction peripheral 100 may further provide the external server or the like with those images.

### Embodiment 2

In Embodiment 1, the mode, which uses the operation guide display to indicate the procedure along which the user is to perform the operation in order to resolve the action required status, has been described.

In the present embodiment, a mode of providing a display with the objective of further drawing the user's attention will be described. An example of a case where the user's attention needs to be drawn is that there is a part which may hurt the user if the operation is erroneously performed within the reach of the user.

For example, it is assumed that there is a fixing unit which becomes hot during printing in a conveyance path 147, and if the user inadvertently operates a cover of the fixing unit and touches the high-temperature fixing unit, the user may get burned.

In that case, a controller 111 of a multifunction peripheral 100 determines that a state sensor 131 has detected the state where a side cover 145 is open and the fixing unit is hot, and sends a notification related to the state to a wearable terminal 200.

When a terminal controller 211, which has received the notification, determines that the image of the user's field of view captured by a terminal image-capturing unit 227 includes the fixing unit, the terminal controller 211 displays, at a position on a terminal display unit 201 corresponding to the fixing unit, an alert display indicating that the user should be cautious of a hot surface, thereby informing the user of danger.

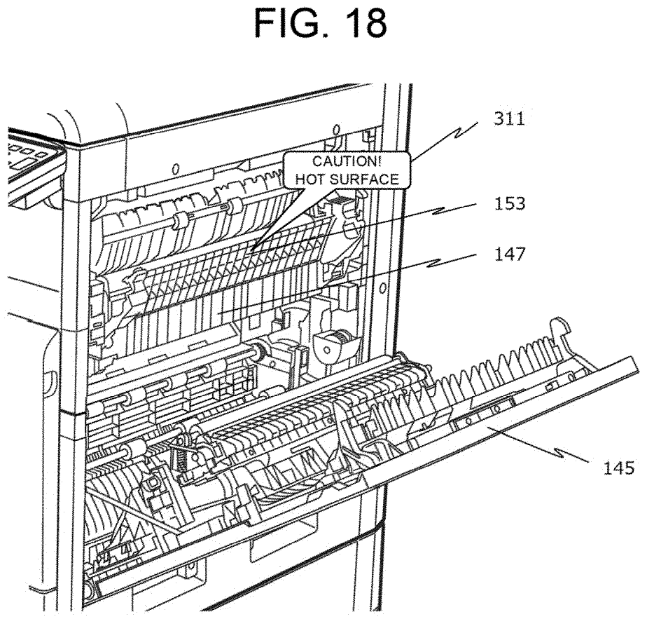

FIG. 18 is an explanatory diagram showing an example of operation assistance information for alert that an operation assistance system of the present embodiment is to provide.

As shown in FIG. 18, when a fixing unit 153 disposed in the conveyance path 147 comes into the user's field of view, the terminal controller 211 displays an alert display 311, which is “Caution! Hot surface”, at a position on the terminal display unit 201 corresponding to the fixing unit 153.

### Embodiment 3

Embodiment 1 and Embodiment 2 perform display on the terminal display unit 201, thereby providing the operation assistance information to the user.

In the present embodiment, a wearable terminal 200 is further provided with a terminal audio unit 229, and uses a sound to provide operation assistance information to the user.

For example, when the operation guide display 301 shown in FIG. 6 is displayed, an audio message, which is “Please open the side cover”, may be output.

Also, for example, when the alert display 311 shown in FIG. 18 is displayed, an audio message, which is “Please do not touch the hot part”, may be output.

Further, the terminal audio unit 229 may pick up the user's voice and recognize an instruction related to the operation assistance information from the user by means of voice recognition technology.

For example, the terminal audio unit 229 may recognize the user' s voice such as “Enlarge the display” or “Turn down the volume” as the instruction, so as to reflect the recognized instruction in the operation assistance information. Alternatively, as the operation assistance information, the terminal audio unit 229 may provide a message, which is “When you have removed the first sheet of the printing paper, please say ‘I took the first sheet.’”, so as to recognize a change in the state on the basis of the user's instruction. In this way, an operation assistance system can provide the operation assistance information while interacting with the user.

As described above, the present invention is characterized in the following respects:

(i) The operation assistance system according to the present invention pertains to a system including an image processing apparatus and a wearable terminal, wherein the image processing apparatus comprises: at least one state sensor which detects whether the image processing apparatus is in an action required status in which action by a user is required; a controller which makes a determination related to the action required status based on detection by the state sensor; and a communication interface circuit which communicates with the wearable terminal, the wearable terminal comprises: a terminal communication interface circuit which communicates with the image processing apparatus; a terminal image-capturing unit which captures an image of at least a part of a field of view of the user in a worn state; a terminal display unit which includes a display area overlapping with at least a part of the field of view of the user in the worn state, and displays information; and a terminal controller which causes operation assistance information to be displayed on the terminal display unit based on communication with the image processing apparatus, and one of the controller and the terminal controller recognizes an image of the user's field of view captured by the terminal image-capturing unit, and determines the operation assistance information to be displayed on the terminal display unit and a position of the operation assistance information on the display area based on the determination related to the action required status.

In the present invention, the image processing apparatus refers to a device which reads an image, outputs an image, or performs both the reading and outputting. A specific mode of the image processing apparatus is, for example, a multifunction peripheral. Note that a method of reading the image or outputting the image is not limited. The multifunction peripheral in the above-described embodiments corresponds to the image processing apparatus of the present invention.

Further, the wearable terminal refers to a device which can be worn by the user and can communicate with the image processing apparatus. The wearable terminal has the function of capturing an image of a part of or all of the field of view of the user (user's field of view) in a worn state of being worn on the user, and also displaying information within a part of or all of the field of view of the user. A specific mode of the wearable terminal is, for example, a communication device which has the shape of spectacles, and can be worn like spectacles. However, the shape is not limited to spectacle-like shape.

At least a part of the area of the user's field of view to be captured and the area of the user's field of view where the terminal display unit can display the information, i.e., the display area, overlap one another. However, the two areas do not need to exactly match with each other.

In addition, the action by the user refers to an operation which the user must perform on the image processing apparatus in order to bring the image processing into a status of being executable. Alternatively, the action refers to an operation which the user must perform on the image processing apparatus in order to prevent the image processing from lapsing into a status of being inexecutable. A specific example of the above is the action of removing the jammed paper when a paper jam occurs. The other examples are the action of supplying printing paper as replenishment for the printing paper which has run out, the action of resupplying toner or ink, and the action of discarding the used toner or ink. However, the actions are not limited to the above. Actions that apply are those taken in cases where the image processing apparatus cannot perform autonomous processing to restore itself to the state of being able to execute the image processing, and the image processing apparatus needs the user's assistance to restore itself.

The state sensor refers to a sensor which performs detection regarding the state (action required status) in which action by the user is required. Specific modes of the state sensors are, for example, a paper jam sensor for detecting a paper jam, a paper out sensor which detects that the printing paper has run out, and a paper residual amount sensor for detecting that the printing paper will soon run out. In addition, sensors for detecting the presence or absence or the quantity of the toner, waste toner, ink, or waste ink are applicable.

Further, the determination related to the action required status includes not only the determination of whether the status corresponds to the action required status, but also the determination of whether one or more operations to resolve the action required status have been performed. In particular, in a case where a plurality of operations need to be performed in order to resolve the action required status, the determination includes determining whether each of the operations has been performed. Also, in a case where operations according to a certain procedure need to be performed, the determination includes determining whether the operation has been performed according to each step of the procedure.

The controller is configured such that the hardware resources including the CPU and the memory, for example, as the main components, and a processing program (software resource) to be executed by the CPU are organically combined in order to realize the function. However, the controller is not limited to the above configuration. The same applies to the terminal controller.

Further, the communication interface circuit is an interface circuit for performing communication. Although the method and mode of communication are not limited, since communication with the wearable terminal is to be performed, wireless communication is extremely desirable. A specific mode of the communication is, for example, communication adopted for Bluetooth (registered trademark) or wireless LAN.

Furthermore, the worn state refers to a state in which the user is wearing and using the wearable terminal.

The terminal image-capturing unit refers to a device which captures objects that come into the field of view of the user as an image. A specific mode of the terminal image-capturing unit is, for example, a small camera. Recently, small and high-performance cameras have been put to practical use in smartphones and automobiles, etc. Therefore, such cameras may be applied.

Further, the user's field of view refers to a range as seen by the user. The terminal image-capturing unit captures an image of the range as seen by the user. That is, when the user changes the direction of his/her face, a surrounding area to be captured by the terminal image-capturing unit is also changed accordingly. A range to be captured by the terminal image-capturing unit does not necessarily have to match with the field of view of the user, that is, the entire range that the user can see with the sight being fixed. Though the range to be captured may be a part of the field of view or wider than the field of view, it should preferably be substantially matching with the field of view.

The terminal display unit refers to a device which displays information within at least a part of the field of view of the user. A specific mode of the terminal display unit is, for example, a transmissive display device capable of displaying information to be superimposed on the user's field of view with a glass surface of the spectacles being used as the display area. Recently, head-up displays which allow pilots and drivers to read indicators while keeping his/her eyes to the front have been put to practical use in aircrafts, automobiles etc. Therefore, the technology of such displays may be applied.

Further, the operation assistance information refers to information for assisting with an operation that the user is to perform in order to resolve the action required status of the image processing apparatus, and set the image processing apparatus back to the image processing-enabled state. For example, information about the operation part and the operation procedure is applicable. Information regarding a procedure for clearing the paper jam in the above-described embodiments corresponds to the operation assistance information.

Preferred modes of the present invention will be further described.

(ii) When one of the controller and the terminal controller recognizes that there is a part where the user is to take an action in the user's field of view captured by the terminal image-capturing unit, the operation assistance information may be displayed at a position corresponding to the part within the display area of the terminal display unit.

Here, the position corresponding to the part mentioned above does not need to exactly match with the part where the user is to take the action. It suffices that a position or a mode is employed to allow the user to understand the correspondence with the part where the user is to take the action. For example, the operation assistance information may be displayed near the part, or the operation assistance information may be displayed at a rear end of an arrow pointing the part.

In this way, the user can easily recognize the part where he/she is to take an action.

(iii) One of the controller and the terminal controller may determine that some action related to the action required status is taken based on at least one of the detection performed by the state sensor and the user's field of view captured by the terminal image-capturing unit, and may make a determination related to an update of the operation assistance information.

By doing so, the operation assistance information is updated according to the action taken by the user. Thus, the user can easily recognize an action that he/she is to take next or completion of the action.

(iv) When one of the controller and the terminal controller recognizes that there is a part which poses a risk of hurting the user in the user's field of view captured by the terminal image-capturing unit, an alert to the user may be displayed at a position corresponding to the part within the display area of the terminal display unit.

By doing so, if there is a part which may hurt the user in a field of view of the user, it is possible to draw the user's attention to that part and avoid the danger.

(v) The wearable terminal may further include a sound notification unit which notifies the user by voice or sound, and the terminal controller may perform control, in performing the display on the terminal display unit, to also issue a notification by voice or sound regarding at least a part of the operation assistance information and a warning to the user.

By doing so, it is possible to provide the operation assistance information to the user not only visually but also through auditory perception.

(vi) A preferred mode of the present invention includes an image processing apparatus which comprises: at least one state sensor which detects whether the image processing apparatus is in an action required status in which action by a user is required; a controller which makes a determination related to the action required status based on detection by the state sensor; and a communication interface circuit which communicates with an external wearable terminal, wherein the communication interface circuit communicates with the wearable terminal, and acquires an image obtained by capturing at least a part of a field of view of the user from the wearable terminal, and the controller recognizes the image acquired from the wearable terminal, determines operation assistance information to be displayed on the wearable terminal based on the determination related to the action required status and the image acquired from the wearable terminal, and sends an instruction to the wearable terminal such that the operation assistance information is displayed correspondingly to a part where the user is to perform an operation.

(vii) A preferred mode of the present invention includes an operation assistance method for an image processing apparatus. The operation assistance method is executed by a controller, and comprises: performing detection, by using a state sensor, of whether the image processing apparatus is in an action required status in which action by a user is required; making a determination related to the action required status based on the detection; communicating with an external wearable terminal, and acquiring an image obtained by capturing at least a part of a field of view of the user from the wearable terminal; recognizing the acquired image; determining, based on the determination related to the action required status and the image acquired from the wearable terminal, operation assistance information to be displayed on the wearable terminal, and a position of the operation assistance information on a display area of the wearable terminal; and sending an instruction to the wearable terminal such that the operation assistance information is displayed on the display area overlapping with at least a part of the field of view of the user.

While the controller may be provided in the image processing apparatus, all of or part of the controller may be provided in the wearable terminal or an external device which is capable of communicating with the image processing apparatus. A mode in which the controller is arranged with the functions thereof being dispersed is also included.

A preferred mode of the present invention also includes a combination of any of the above-described modes.

Various modification of the present invention may be implemented besides the above-described embodiments. Such modifications should not be construed as falling outside the scope of the present invention. The present invention is embodied by the claims and their equivalents, and should embrace all of the modifications within the above scope.

What is claimed is:

1. An operation assistance system including an image processing apparatus and a wearable terminal, the image processing apparatus comprising:
at least one state sensor which detects whether the image processing apparatus is in an action required status in which action by a user is required;
a controller which makes a determination related to the action required status based on detection by the state sensor; and
a communication interface circuit which communicates with the wearable terminal,
the wearable terminal comprising:
a terminal communication interface circuit which communicates with the image processing apparatus;
a terminal image-capturing unit which captures an image of at least a part of a field of view of the user in a worn state;
a terminal display unit which includes a display area overlapping with at least a part of the field of view of the user in the worn state, and displays information; and
a terminal controller which causes operation assistance information to be displayed on the terminal display unit based on communication with the image processing apparatus, wherein
one of the controller and the terminal controller recognizes an image of the user's field of view captured by the terminal image-capturing unit, and determines the operation assistance information to be displayed on the terminal display unit and a position of the operation assistance information on the display area based on the determination related to the action required status.

2. The operation assistance system according to claim 1, wherein when one of the controller and the terminal controller recognizes that there is a part where the user is to take an action in the user's field of view captured by the terminal image-capturing unit, the operation assistance information is displayed at a position corresponding to the part within the display area of the terminal display unit.

3. The operation assistance system according to claim 1, wherein one of the controller and the terminal controller determines that some action related to the action required status is taken based on at least one of the detection performed by the state sensor and the user's field of view captured by the terminal image-capturing unit, and makes a determination related to an update of the operation assistance information.

4. The operation assistance system according to claim 1, wherein when one of the controller and the terminal controller recognizes that there is a part which poses a risk of hurting the user in the user's field of view captured by the terminal image-capturing unit, an alert to the user is displayed at a position corresponding to the part within the display area of the terminal display unit.

5. The operation assistance system according to claim 2, wherein
the wearable terminal further comprises a sound notification unit which notifies the user by voice or sound, and
the terminal controller performs control, in performing the display on the terminal display unit, to also issue a notification by voice or sound regarding at least a part of the operation assistance information and a warning to the user.

6. An image processing apparatus comprising:
at least one state sensor which detects whether the image processing apparatus is in an action required status in which action by a user is required;
a controller which makes a determination related to the action required status based on detection by the state sensor; and
a communication interface circuit which communicates with an external wearable terminal, wherein
the communication interface circuit communicates with the wearable terminal, and acquires an image obtained by capturing at least a part of a field of view of the user from the wearable terminal, and
the controller recognizes the image acquired from the wearable terminal, determines operation assistance information to be displayed on the wearable terminal based on the determination related to the action required status and the image acquired from the wearable terminal, and sends an instruction to the wearable terminal such that the operation assistance information is displayed correspondingly to a part where the user is to perform an operation.

7. An operation assistance method for an image processing apparatus, the operation assistance method being executed by a controller, and comprising:
performing detection, by using a state sensor, of whether the image processing apparatus is in an action required status in which action by a user is required;
making a determination related to the action required status based on the detection;
communicating with an external wearable terminal, and acquiring an image obtained by capturing at least a part of a field of view of the user from the wearable terminal;
recognizing the acquired image;
determining, based on the determination related to the action required status and the image acquired from the wearable terminal, operation assistance information to be displayed on the wearable terminal, and a position of the operation assistance information on a display area of the wearable terminal; and
sending an instruction to the wearable terminal such that the operation assistance information is displayed on the display area overlapping with at least a part of the field of view of the user.
